(19) United States
(12) Patent Application Publication
(10) Pub. No.: US 2017/0009831 A1
(43) Pub. Date: Jan. 12, 2017

(54) TRANSMISSION BRAKE DEVICE

(71) Applicant: MAZDA MOTOR CORPORATION, Hiroshima (JP)

(72) Inventors: Tatsuhiko IWASAKI, Hiroshima-shi (JP); Shinya KAMADA, Kure-shi (JP); Yasuhiro OGAUCHI, Higashihiroshima-shi (JP)

(73) Assignee: MAZDA MOTOR CORPORATION, Hiroshima (JP)

(21) Appl. No.: 15/119,474

(22) PCT Filed: Feb. 20, 2015
(86) PCT No.: PCT/JP2015/054867

§ 371 Date: Aug. 17, 2016

(30) Foreign Application Priority Data
Mar. 31, 2014 (JP) 2014-071577

(51) Int. Cl. F16D 65/18; F16D 55/00; F16D 25/0635; B60T 1/06; F16H 63/30; F16D 13/46

(52) U.S. Cl. CPC F16D 65/186; F16H 63/3026; F16D 13/46; F16D 25/0635; B60T 1/062; F16D 55/00; F16H 3/66

(57) ABSTRACT

A transmission brake device includes: a friction plate set configured such that a plurality of rotation-side friction plates; an engaging piston disposed on an axial side of the friction plate set; a clearance adjustment piston disposed on a side of the engaging piston opposite to the friction plate set,; a clearance adjustment hydraulic chamber configured to move the clearance adjustment piston; and an engaging hydraulic chamber configured to move the engaging piston; a biasing member disposed between each adjacent pair of the fixed-side friction plates, the biasing member being configured to bias each adjacent pair of the fixed-side friction plates in directions away from each other. The biasing member distributes the clutch clearance in a gap between each adjacent pair of the fixed-side friction plates when a hydraulic pressure is supplied only to the clearance adjustment hydraulic chamber.

### TECHNICAL FIELD

The present invention relates to a transmission brake device to be mounted in a vehicle, and belongs to the technical field of a vehicular transmission.

### BACKGROUND ART

A transmission to be mounted in a vehicle such as an automatic transmission is configured such that gearshift is automatically performed by selective engagement of a power transmission path constituted by a planetary gear mechanism and the like with a plurality of hydraulic friction engagement elements. Each gear position is basically formed by engagement of two friction engagement elements. Conventionally, regarding a first gear position in the D-range, it is a usual practice to form the gear position by one friction engagement element and an OWC (one-way clutch) for the purpose of a smooth gearshift operation and the like.

However, the OWC costs high. Further, a rotational resistance may be generated in a gear position other than the first gear position in the D-range. This may obstruct improvement of fuel economy of an engine. In view of the above, in recent years, abolishing use of the OWC is proposed or executed.

For instance, the first gear position is formed by engagement of a friction engagement element such as a low clutch, which is engaged with a predetermined low speed gear positions including the first gear position, and a friction engagement element such as a low reverse brake, which is engaged with the first gear position and a reverse gear position. Gearshift to the first gear position is performed by engagement of the latter friction engagement element in a state that the former friction engagement element is engaged. Therefore, in order to smoothly shift from another gear position to the first gear position, it is necessary to finely control the timing or the engaging force in engaging a friction engagement element such as the low reverse brake.

In order to cope with the aforementioned problem, Patent Literature 1 discloses a low reverse brake using a tandem hydraulic actuator including two pistons.

As illustrated in FIG. 13A and FIG. 13B, a brake device 100 is configured such that a plurality of fixed-side friction plates 103 that are spline-engaged with an inner surface of a transmission case, and a plurality of rotation-side friction plates 104 that are spline-engaged with an outer surface of a rotary member are alternately disposed between a transmission case 101, and a rotary member 102 accommodated in the case 101; and the brake device is provided with an engaging piston 106 for engaging the friction plates 103 and 104 against a biasing force of a return spring 105, and a clearance adjustment piston 107 disposed behind the piston 106.

In the brake device 100, as illustrated in FIG. 13A, at the time of non-engagement, the pistons 106 and 107 are held at a retracted position by a biasing force of the return spring 105, and a relatively large clutch clearance (a value obtained by subtracting the sum of the thicknesses of all the friction plates from a distance between the engaging piston and a retaining plate) is formed.

When a hydraulic pressure is supplied to a hydraulic chamber 109 of the clearance adjustment piston 107 (hereinafter, referred to as a “clearance adjustment hydraulic chamber”) from the aforementioned state, as illustrated in FIG. 13B, the pistons 106 and 107 are advanced to a stroke end of the clearance adjustment piston 107 against a biasing force of the return spring 105. Thereby, the clutch clearance is reduced by a distance by which the pistons 106 and 107 are advanced.

Therefore, by supplying a hydraulic pressure to the clearance adjustment hydraulic chamber 109, it is possible to engage the friction plates 103 and 104 with enhanced responsiveness when a hydraulic pressure is supplied to a hydraulic chamber 110 of the engaging piston 106 (hereinafter, referred to as an “engagement hydraulic chamber”). Thus, it is possible to finely control the timing or the engaging force of an engaging operation. On the other hand, at the time of release, namely, when a hydraulic pressure is not supplied to the hydraulic chambers 109 and 110, and the pistons 106 and 107 are held at a retracted position by a biasing force of the return spring 105, a relatively large clutch clearance is formed. Therefore, a sliding resistance between the fixed-side friction plates 103 and the rotation-side friction plates 104, namely, a resistance of a rotary member is small. This makes it possible to improve the fuel economy of an engine, and to suppress an increase in electric power consumption of a motor.

However, in the brake device described in Patent Literature 1, at the time of non-engagement, a gap between each adjacent pair of the friction plates may vary, and a sliding resistance between the friction plates may increase at a portion where the gap is small. An increase in the sliding resistance between the friction plates may lead to drive loss increase in a transmission as a whole, and may deteriorate the fuel economy.

### CITATION LIST

### Patent Literature

Patent Literature 1: Japanese Unexamined Patent Publication No. 2005-265063

### SUMMARY OF INVENTION

An object of the present invention is to provide a transmission brake device including an engaging piston and a clearance adjustment piston, which enables to securely reduce a sliding resistance between friction plates at the time of non-engagement.

An aspect of the invention is directed to a transmission brake device including a friction plate set configured such that a plurality of rotation-side friction plates that are axially movably engaged with a predetermined rotary member, and a plurality of fixed-side friction plates that are axially movably engaged with a transmission case are alternately disposed; an engaging piston disposed on an axial side of the friction plate set; a clearance adjustment piston disposed on a side of the engaging piston opposite to the friction plate set, and configured to move the engaging piston toward the side of the friction plate set so as to adjust a clutch clearance; a clearance adjustment hydraulic chamber configured to move the clearance adjustment piston toward the side of the friction plate set when a hydraulic pressure is supplied to the clearance adjustment hydraulic chamber; and an engaging hydraulic chamber configured to move the engaging piston toward the side of the friction plate set when a hydraulic pressure is supplied to the engaging hydraulic chamber. The transmission brake device includes a biasing member disposed between each adjacent pair of the fixed-side friction plates, the biasing member being configured to bias each adjacent pair of the fixed-side friction plates in directions away from each other. The biasing member distributes the clutch clearance in a gap between each adjacent pair of the fixed-side friction plates when a hydraulic pressure is supplied only to the clearance adjustment hydraulic chamber out of the clearance adjustment hydraulic chamber and the engaging hydraulic chamber.

### BRIEF DESCRIPTION OF DRAWINGS

FIG. 1 is a schematic diagram of an automatic transmission according to a first embodiment of the present invention;

FIG. 2 is a table illustrating a relationship between combinations of engagements of friction engagement elements, and gear positions;

FIG. 3 is a sectional view of a brake device according to the first embodiment;

FIG. 4 is a sectional view of the brake device according to the first embodiment taken along another section line;

FIG. 5 is a sectional view of the brake device taken along the line Y5-Y5 in FIG. 3;

FIG. 6 is an essential-part enlarged view enlargedly illustrating essential parts in FIG. 5;

FIG. 7 is a sectional view illustrating a state when a hydraulic pressure is supplied to a clearance adjustment hydraulic chamber of the brake device according to the first embodiment;

FIG. 8 is an explanatory diagram (a diagram corresponding to FIG. 5) of a brake device according to a second embodiment;

FIG. 9 is an explanatory diagram (a diagram corresponding to FIG. 5) of a brake device according to a third embodiment;

FIG. 10 is a sectional view of a brake device according to a fourth embodiment;

FIG. 11 is an explanatory diagram (a diagram corresponding to FIG. 6) of a brake device according to a fifth embodiment;

FIG. 12 is an explanatory diagram (a diagram corresponding to FIG. 6) of a brake device according to a sixth embodiment; and

FIGS. 13A and 13B are sectional views illustrating a conventional brake device of an automatic transmission.

### DESCRIPTION OF EMBODIMENTS

In the following, embodiments in which the present invention is applied to an automatic transmission are described.

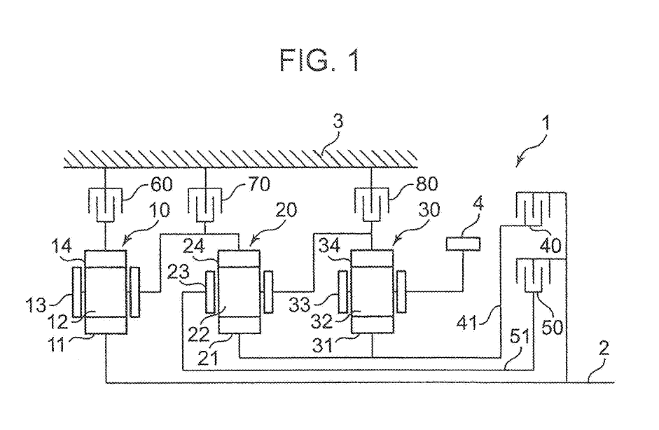

FIG. 1 is a schematic diagram illustrating a configuration of an automatic transmission embodying the present invention. An automatic transmission 1 includes an input shaft 2 to which an engine output is input via a torque converter (not illustrated). A first planetary gear set 10, a second planetary gear set 20, and a third planetary gear set 30 (hereinafter, referred to as “first, second, and third gear sets”) are disposed on the input shaft 2 in this order from the side opposite to the drive source side (from the left side in FIG. 1). Further, the automatic transmission 1 is provided with, as hydraulic friction engagement elements for switching a power transmission path constituted by the gear sets 10, 20, and 30, a low clutch 40 and a high clutch 50 for selectively transmitting power from the input shaft 2 to the gear sets 10, 20, and 30; and a R35 brake 60, a 26 brake 70, and an LR brake 80 for fixing predetermined rotary elements of each of the gear sets 10, 20, and 30.

The gear set 10 (20, 30) is constituted by a sun gear 11 (21, 31), a plurality of pinion gears 12 (22, 32), each of which is engaged with the sun gear 11 (21, 31), a carrier 13 (23, 33) which supports the pinion gears 12, (22, 32), and a ring gear 14 (24, 34) which is engaged with the pinion gears 12 (22, 32).

The input shaft 2 is directly connected to the sun gear 11 of the first gear set 10. The sun gear 21 of the second gear set 20, and the sun gear 31 of the third gear set 30 are connected to each other, and are connected to an output member 41 of the low clutch 40. Further, the carrier 23 of the second gear set 20 is connected to an output member 51 of the high clutch 50.

Further, the R35 brake 60 is disposed between the ring gear 14 of the first gear set 10 and a transmission case 3. The ring gear 24 of the second gear set 20 and the carrier 13 of the first gear set 10 are connected to each other. The 26 brake 70 is disposed between the ring gear 24 and the carrier 13, and the transmission case 3. Further, the ring gear 34 of the third gear set 30 and the carrier 23 of the second gear set 20 are connected to each other. The LR brake 80 is disposed between the ring gear 34 and the carrier 23, and the transmission case 3. Further, an output gear 4 for outputting an output of the automatic transmission 1 to drive wheels (not illustrated) is connected to the carrier 33 of the third gear set 30.

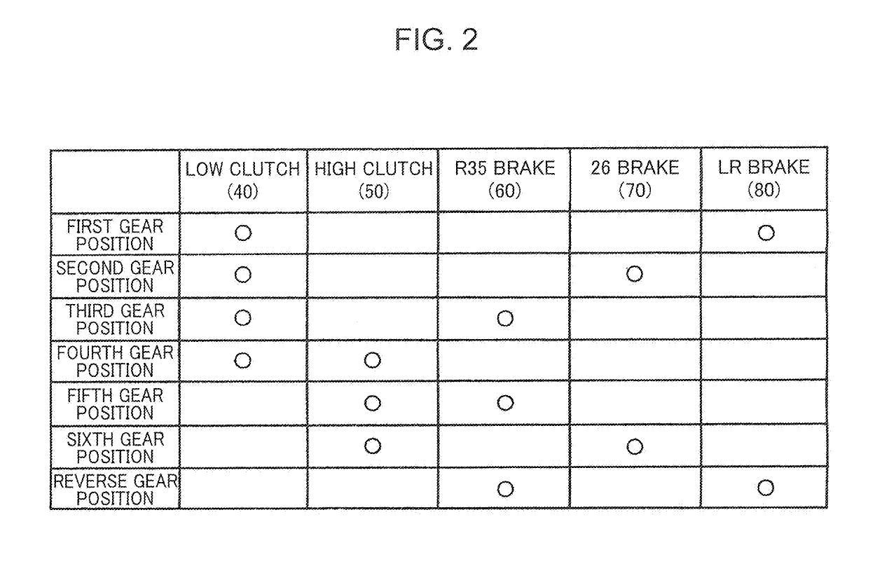

As illustrated in FIG. 2, the automatic transmission 1 having the aforementioned configuration provides first to sixth gear positions in the D-range, and a reverse gear position in the R-range by combining engagement states of the low clutch 40, the high clutch 50, the R35 brake 60, the 26 brake 70, and the LR brake 80.

In this example, the LR brake 80 disposed on the outer peripheral side of the third gear set 30 in this embodiment corresponds to a brake device to which the present invention is applied. In the following, description is made based on the premise that the LR brake 80 is a brake device according to the present invention.

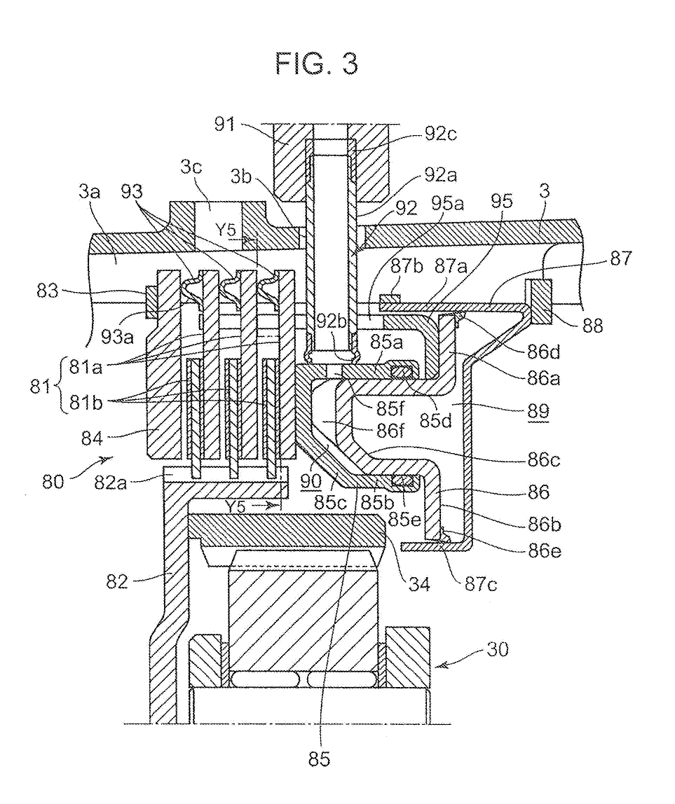

As illustrated in FIG. 3, the brake device 80 according to the first embodiment includes a friction plate set 81 configured such that a plurality of fixed-sided friction plates 81a whose outer peripheral portion is engaged with a spline 3a formed on the inner surface of the transmission case 3, and a plurality of rotation-side friction plates 81b whose inner peripheral portion is engaged with a spline 82a formed on the outer surface of a hub member 82 as a rotary member are alternately disposed. The hub member 82 is connected to the ring gear 34 of the third gear set 30, and to the carrier 23 of the second gear set 20 illustrated in FIG. 1.

A retaining plate 84 is disposed on the side opposite to the drive source side of the friction plate set 81 (hereinafter, the side opposite to the drive source side is referred to as a “rear side”, and the drive source side is referred to as a “front side”) in a state that the retaining plate 84 is engaged with the spline 3a of the transmission case 3 in the same manner as the fixed-side friction plates 81a, and slipping off thereof toward the rear side is prevented by a snap ring 83.

On the front side of the friction plate set 81, an engaging piston 85 for engaging the fixed-side friction plates 81a and the rotation-side friction plates 81b, a clearance adjustment piston 86 for moving the engaging piston 85 toward the side of the friction plate set so as to adjust a clutch clearance, and a cylinder 87 in which the pistons 85 and 86 are accommodated are disposed in this order. The clearance adjustment piston 86 is a piston for use in setting a clutch clearance small in advance at the time of engagement of the brake device 80.

The cylinder 87 is a ring-shaped member made of a thin metal plate and having a generally U-shape in section. A projection 87b formed on an outer surface portion 87a of the cylinder 87 is engaged with the transmission case 3 in a state that the outer surface portion 87a is engaged in the inner surface of the transmission case 3 to prevent rotation of the cylinder 87. Further, slipping off of the cylinder 87 toward the front side is prevented by a snap ring 88.

The clearance adjustment piston 86 includes a flange portion 86a on the outer peripheral side and a flange portion 86b on the inner peripheral side, and a bulging portion 86c of a generally U-shape in section formed at a middle position radially of the flange portions 86a and 86b and bulging toward the friction plate set 81 on the rear side. The clearance adjustment piston 86 is placed into the cylinder 87 from the rear side. Seal members 86d and 86e mounted on the peripheral edges of the flange portions 86a and 86b respectively slidably and oil-tightly come into pressing contact with the inner surface of the outer surface portion 87a of the cylinder 87 and with the outer surface of an inner surface portion 87c of the cylinder 87. Thus, a clearance adjustment hydraulic chamber 89 is oil-tightly formed by the cylinder 87 and the clearance adjustment piston 86.

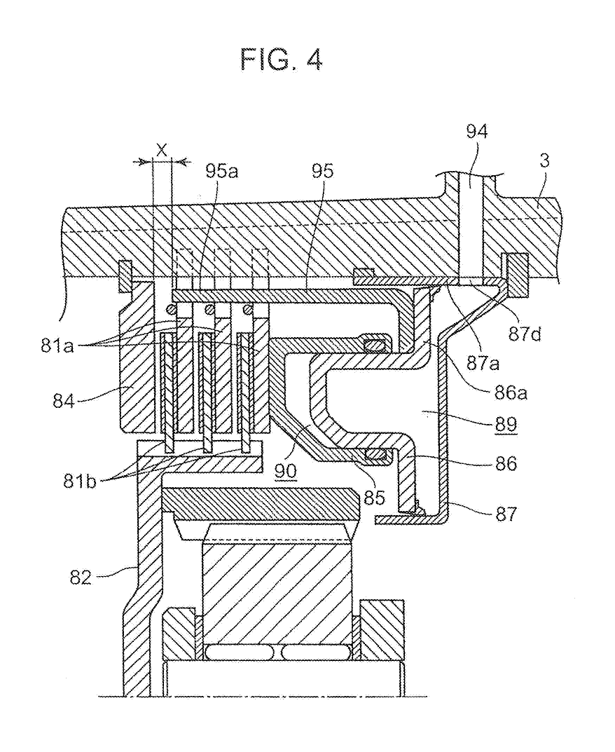

As illustrated in FIG. 4, an adjustment hydraulic oil supply passage 94 is formed with respect to the clearance adjustment hydraulic chamber 89 in such a manner that the adjustment hydraulic oil supply passage 94 passes through the transmission case 3, and is connected to an opening portion 87d formed in the outer surface portion 87a of the cylinder 87.

When a hydraulic pressure for clearance adjustment is supplied to the clearance adjustment hydraulic chamber 89, the clearance adjustment piston 86 is moved toward the side of the friction plate set 81, thereby causing the engaging piston 85 to move toward the side of the friction plate set 81 via the clearance adjustment piston 86. According to this configuration, in engagement of the friction plates 81a and 81b, the position of the engaging piston 85 is adjusted in advance to a position where a predetermined clutch clearance is formed.

A stopper member 95 is provided in the clearance adjustment piston 86 so that a stroke of the piston toward the side of the friction plate set 81 when a hydraulic pressure for clearance adjustment is supplied to the clearance adjustment hydraulic chamber 89 is set at a position where a predetermined clutch clearance is formed so as to minimize the clutch clearance.

The comb-shaped stopper member 95 extending toward the side of the friction plate set 81 while passing along the outer peripheral side of the engaging piston 85 is fixedly mounted to a surface of the flange portion 86a on the outer peripheral side of the clearance adjustment piston 86, on the side of the friction plate set 81. The stopper member 95 extends on the inner peripheral side of the inner surface of the transmission case 3, and on the outer peripheral side of the rotation-side friction plates 81b.

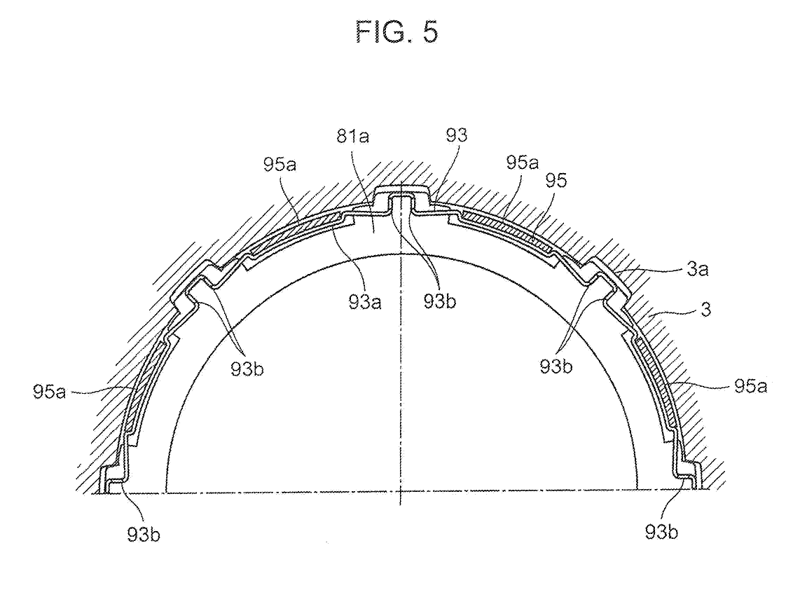

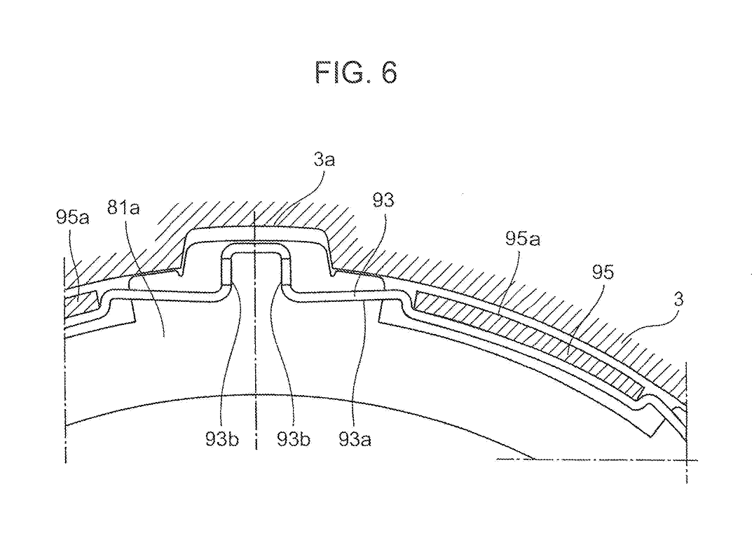

A plurality of teeth 95a formed circumferentially of the stopper member 95 are configured such that as illustrated in FIG. 5 and FIG. 6, the teeth 95a pass through a valley of a spline on the outer periphery of the fixed-side friction plates 81a, tip ends of the teeth 95a face the front surface of the retaining plate 84, and as illustrated in FIG. 4, a gap corresponding to a predetermined distance x is formed between a tip end surface of each of the teeth 95a and the front surface of the retaining plate 84 in a release state of the brake device 80, namely, at a retracted position of the pistons 85 and 86.

On the other hand, the engaging piston 85 includes a bulging portion 85c of a generally U-shape in section and bulging toward the friction plate set 81 on the rear side. The bulging portion 86c of the clearance adjustment piston 86 is received in the bulging portion 85c of the engaging piston 85. An outer periphery and an inner periphery of the bulging portion 86c received in the bulging portion 85c are respectively slidably and oil-tightly sealed by seal members 85d and 85e.

The seal members 85d and 85e are mounted on groove portions for seal members, which are respectively formed in an outer circumferential wall 85a and in an inner circumferential wall 85b of the bulging portion 85c of the engaging piston 85. An engaging hydraulic chamber 90 is oil-tightly formed by the engaging piston 85 and the clearance adjustment piston 86.

In this example, a projecting portion 86f facing the inner surface of the engaging piston 85 is formed on the bulging portion 86c of the clearance adjustment piston 86 to restrict relative movement of the clearance adjustment piston 86 with respect to the engaging piston 85 toward the side of the friction plate set 81 at a predetermined position, and to secure a space of a predetermined volume, which serves as the engaging hydraulic chamber 90.

Further, an oil supply port 85f is formed in the outer circumferential wall 85a of the bulging portion 85c of the engaging piston 85. An oil supply pipe 92 extending from a hydraulic oil supply device 91 on the outside of the transmission case 3 passes through an opening portion 3b formed in the transmission case 3, and extends radially inwardly toward the oil supply port 85f.

The oil supply pipe 92 includes a pipe body 92a, and a seal member 92b which is mounted to a tip end of the pipe body 92a, and is made of rubber, soft resin, or the like with a certain elasticity. By pressingly mounting the oil supply pipe 92 on the outer surface of the outer circumferential wall 85a of the bulging portion of the engaging piston 85 in a state that the tip end of the seal member 92b surrounds the oil supply port 85f, the oil supply pipe 92, and the oil supply port 85f to the engaging hydraulic chamber 90 are oil-tightly communicated to each other within the stroke range of the engaging piston 85.

Note that the oil supply pipe 92 extends radially from the outside toward the engaging piston 85 through a gap between the adjacent teeth of the stopper member 95 in order to avoid interference with the stopper member 95.

Further, a seal member 92c is provided on an upper end of the pipe body 92a placed in the hydraulic oil supply device 91. Further, although not illustrated, the opening portion 3b of the transmission case 3 is sealed in a state that the oil supply pipe 92 passes through the opening portion 3b. Further, the transmission case 3 is formed with an oil supply port 3c for supplying lubrication oil from the outside to the friction plate set 81 in the brake device 80.

When a hydraulic pressure for engagement is supplied to the engaging hydraulic chamber 90 in a state that a hydraulic pressure for clearance adjustment is supplied to the clearance adjustment hydraulic chamber 89, the engaging piston 85 is moved toward the side of the friction plate set 81. Then, the fixed-side friction plates 81a and the rotation-side friction plates 81b constituting the friction plate set 81 are pressingly held between the engaging piston 85 and the retaining plate 84. Thereby, the brake device 80 is engaged, and the hub member 82 to the carrier 23 of the second gear set 20, and the ring gear 34 of the third gear set 30 are fixed.

Further, in the brake device 80, a biasing member 93 is disposed between each adjacent pair of the fixed-side friction plates 81a. The biasing member 93 is provided to resiliently bias each adjacent pair of the fixed-side friction plates 81a in directions away from each other. A biasing member 93 configured in the same manner as described above is also disposed between the retaining plate 84, and the fixed-side friction plate 81a adjacent to the retaining plate 84. These biasing members 93 are disposed on the outer peripheral side of the rotation-side friction plates 81b.

In this example, as illustrated in FIG. 3 to FIG. 5, for instance, the biasing member 93 is formed by bending a wire member. The biasing member 93 is provided with an annular body portion 93a formed into an annular shape. A biasing portion 93b for biasing each adjacent pair of the fixed-side friction plates 81a, or the fixed-side friction plate 81a and the retaining plate 84 adjacent to the fixed-side friction plate 81a in directions away from each other is formed at plural positions circumferentially of the annular body portion 93a.

Each of the biasing portions 93b is formed to project toward the rear side by bending a wire member into a generally V-shape in section. The biasing portion 93b is disposed such that the open angle between a pair of slope portions of a generally V-shape is resiliently changeable, and a biasing force can be axially imparted in a state that the biasing portion 93b is axially compressed, in other words, in a state that the open angle is set large.

The biasing members 93 having the same configuration as each other are disposed between each adjacent pair of the fixed-side friction plates 81a, and between the retaining plate 84 and the fixed-side friction plate 81a adjacent to the retaining plate 84. The biasing members 93 are provided to distribute a clutch clearance in a gap between each adjacent pair of the fixed-side friction plates. Further, these biasing members 93 also function as a return spring for moving the engaging piston 85 toward the side opposite to the side of the friction plate set.

Next, an operation of the first embodiment is described. At the time of engagement, a hydraulic pressure is supplied from the state illustrated in FIG. 3 and FIG. 4 to the clearance adjustment hydraulic chamber 89 through the adjustment hydraulic oil supply passage 94. By supply of the hydraulic pressure, the clearance adjustment piston 86 is stroked toward the side of the friction plate set 81, and the projecting portion 86f formed at a tip end of the bulging portion 86c of the clearance adjustment piston 86 is abutted against the inner surface of the engaging piston 85. Thereby, the engaging piston 85 is also stroked toward the side of the friction plate set 81.

Then, at a point of time when the clearance adjustment piston 86 is stroked or moved by the distance x, the tip ends of the teeth 95a of the comb-shaped stopper member 95 formed on the clearance adjustment piston 86 are abutted against the front surface of the retaining plate 84, and strokes of the pistons 85 and 86 are restricted in this state.

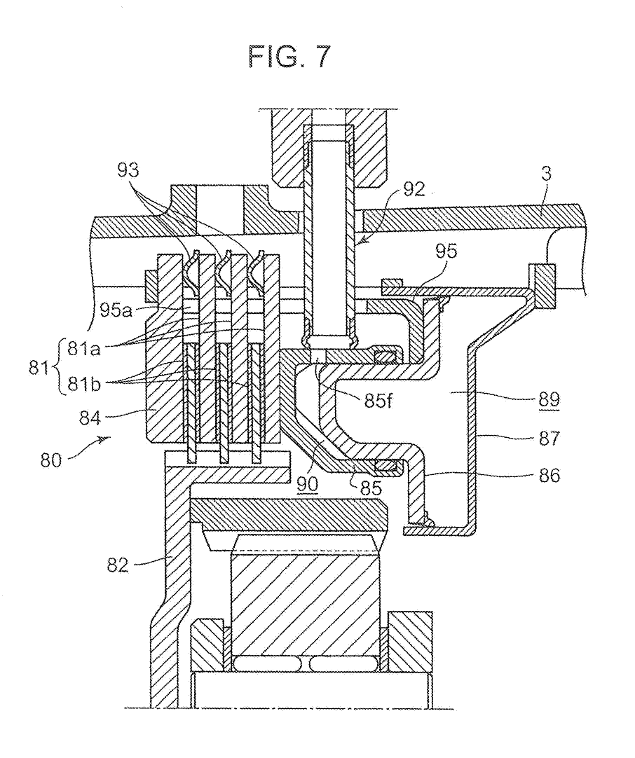

In this state, as illustrated in FIG. 7, the gap between each adjacent pair of the fixed-side friction plates 81a and 81a, and the gap between the rearmost fixed-side friction plate 81a and the retaining plate 84 are narrowed against biasing forces of the biasing members 93, and the clutch clearance is set to a very small value close to 0 e.g. 1 mm. The clutch clearance is distributed in a gap between each adjacent pair of the fixed-side friction plates.

Next, a hydraulic pressure is supplied to the engaging hydraulic chamber 90 by the oil supply pipe 92. When the engaging piston 85 presses the friction plate set 81, and the friction plate set 81 is pressed against the retaining plate 84, the rotation-side friction plates 81b are pressingly held between the fixed-side friction plates 81a and the retaining plate 84. Thus, the brake device 80 is engaged.

The clutch clearance is set to a very small value close to 0 in advance. Therefore, the brake device 80 is engaged speedily by supply of a hydraulic pressure for engagement, and an engaging operation with high responsiveness is obtained. On the other hand, when the brake device 80 is in a release state, namely, when the pistons 85 and 86 are located at a retracted position, a large clutch clearance is secured. Therefore, an increase in rotational resistance by slide contact of the fixed-sided friction plates 81a and the retaining plate 84 with the rotation-side friction plates 81b is suppressed. This makes it possible to improve the fuel economy of an engine in a release state, and to obtain enhanced responsiveness at the time of engagement of the brake device 80.

As described above, in the brake device 80 according to the first embodiment, the engaging piston 85 and the clearance adjustment piston 86 are disposed on an axial side of the friction plate set 81 constituted by the fixed-side friction plates 81a and the rotation-side friction plates 81b; the biasing member 93 for biasing each adjacent pair of the fixed-side friction plates 81a in directions away from each other is disposed between each adjacent pair of the fixed-side friction plates 81a; and the biasing member 93 is provided in such a manner that a clutch clearance is distributed in a gap between each adjacent pair of the fixed-side friction plates when a hydraulic pressure is supplied only to the clearance adjustment hydraulic chamber 89.

According to the aforementioned configuration, it is possible to suppress a variation in the gap between each adjacent pair of the fixed-side friction plates 81a, and to make the gaps substantially uniform when a clutch clearance is reduced. This makes it possible to reduce a sliding resistance between friction plates, as compared with a configuration, in which the gaps are non-uniform. This is advantageous in improving the fuel economy.

Further, the biasing member 93 disposed between each adjacent pair of the fixed-side friction plates 81a can be used as a return spring for moving the engaging piston 85 toward the side opposite to the side of the friction plate set. This is advantageous in obtaining the aforementioned effects without the need of additionally providing a return spring.

Further, the biasing member 93 is circumferentially provided with a plurality of the biasing portions 93b for biasing each adjacent pair of the fixed-side friction plates 81a in directions away from each other. This makes it possible to reduce the number of steps of assembling a biasing member, as compared with a configuration, in which a plurality of biasing members are provided circumferentially in a gap between each adjacent pair of the fixed-side friction plates 81a. This is advantageous in improving productivity.

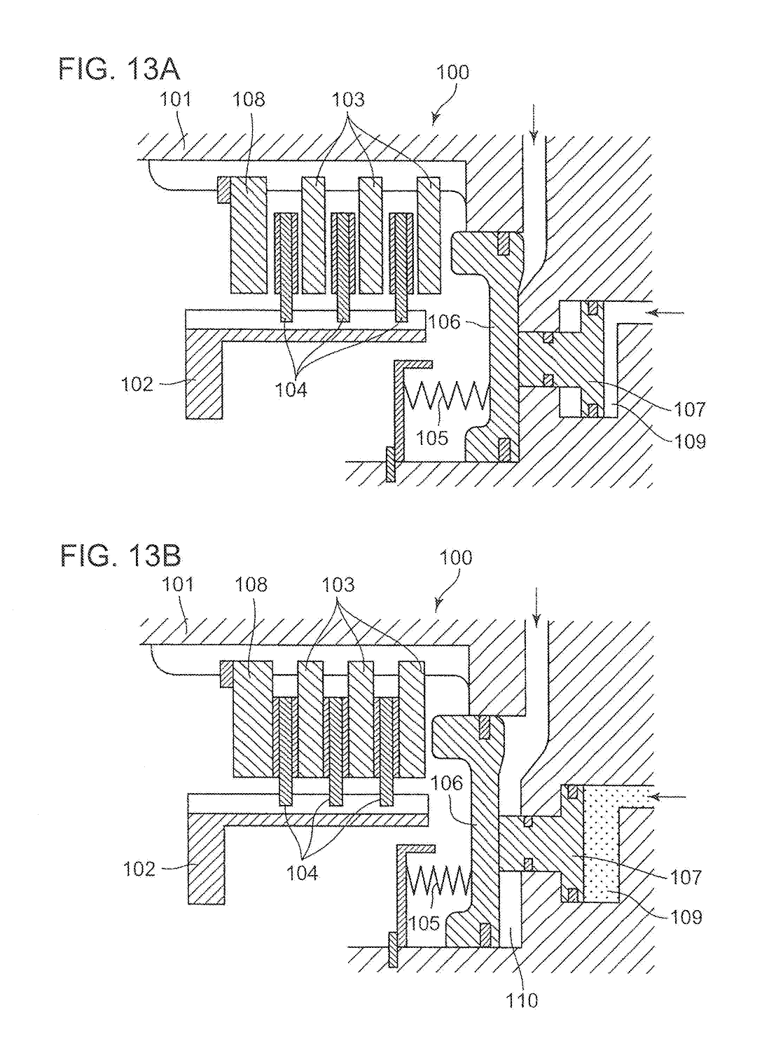

Further, the engaging hydraulic chamber 90 is formed by the bulging portion 85c of the engaging piston 85 bulging toward the side of the friction plate set 81, and the bulging portion 86c of the clearance adjustment piston 86 bulging toward the side of the friction plate set 81 and received in the bulging portion 85c. This makes it possible to keep the volume of the engaging hydraulic chamber 90 substantially unchanged when the clearance adjustment piston 86 is moved toward the side of the friction plate set 81. According to this configuration, as compared with a configuration, in which the volume of an engaging hydraulic chamber is increased, as exemplified by the brake device 100 illustrated in FIG. 13A and FIG. 13B, it is possible to form the engaging hydraulic chamber 90 with a small size. Forming the engaging hydraulic chamber 90 with a small size is advantageous in engaging the friction plates with enhanced responsiveness, and in finely controlling the timing or the engaging force of an engaging operation.

Further, the stopper member 95 is fixed to the clearance adjustment piston 86, and extends axially toward the other side with respect to the clearance adjustment piston 86. The stopper member 95 is configured such that the axial other end of the clearance adjustment piston 86 is abutted against the retaining plate 84 when the clearance adjustment piston 86 is moved toward the side of the friction plate set 81 to restrict movement of the clearance adjustment piston 86 at a position where a predetermined clutch clearance is formed.

According to this configuration, for instance, it is possible to securely restrict movement of the clearance adjustment piston with a relatively simplified configuration, without forming a groove portion for a seal member to mount the seal member, as exemplified by the brake device 100 illustrated in FIG. 13A and FIG. 13B, or forming a groove portion for a snap ring to mount the snap ring. Further, the aforementioned configuration is advantageous in improving productivity, as compared with a configuration, in which a groove portion for a seal member is formed in a clearance adjustment piston to mount the seal member, or a groove portion for a snap ring is formed to mount the snap ring.

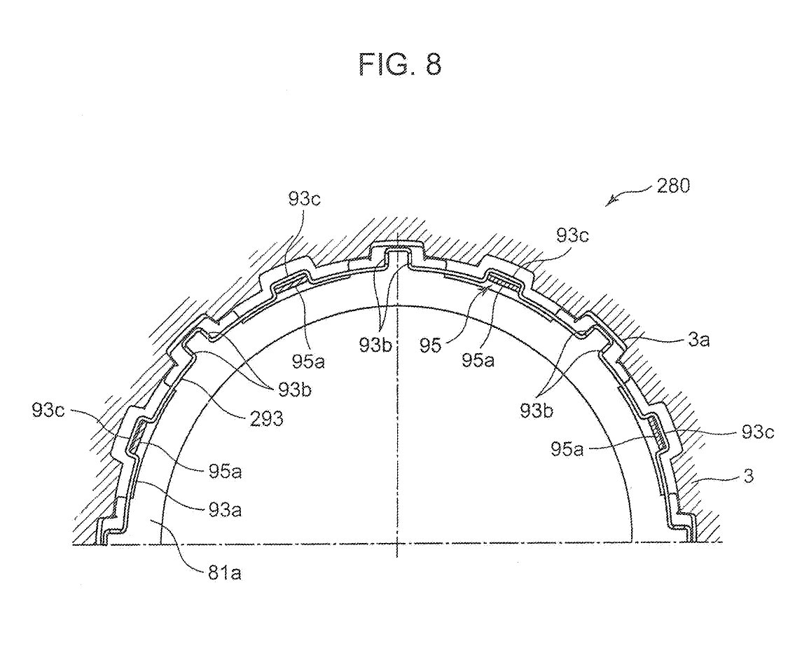

In the brake device 80 according to the first embodiment, as illustrated in FIG. 5 and FIG. 6, the teeth 95a of the stopper member 95 extend along the outer peripheral side of the biasing members 93. Alternatively, as exemplified by a brake device 280 according to a second embodiment illustrated in FIG. 8, it is possible to extend the teeth of a stopper member along the inner peripheral side of biasing members.

In the brake device 280 according to the second embodiment, a biasing member 293 is formed with convex portions 93c, each of which projects into a rectangular shape on the outer peripheral side of an annular body portion 93a of the biasing member 293. Teeth 95a of a stopper member 95 extend through a gap between a transmission case 3 and fixed-side friction plates 81a, and extend on the inner peripheral side of the convex portions 93c of the biasing member 293.

Also, in this embodiment, the stopper member 95 is abutted against a retaining plate 84 when a clearance adjustment piston 86 is moved toward the side of a friction plate set 81 to restrict movement of the clearance adjustment piston 86 at a position where a predetermined clutch clearance is formed. This is advantageous in securely restricting movement of the clearance adjustment piston with a relatively simplified configuration.

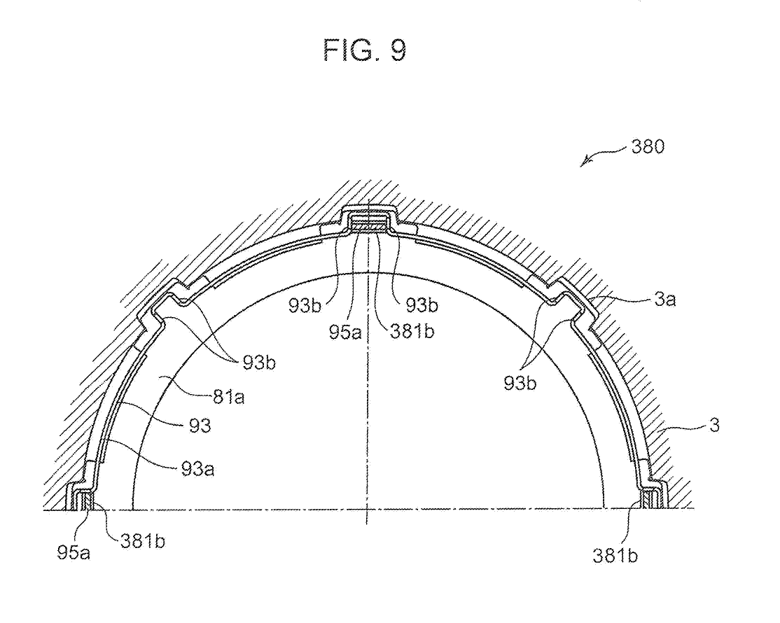

Further, in the brake device 80 of the first embodiment, and in the brake device 280 of the second embodiment, the teeth 95a of the stopper member 95 extend through a gap between the transmission case 3 and the fixed-side friction plates 81a. Alternatively, as exemplified by a brake device 380 according to a third embodiment illustrated in FIG. 9, it is possible to extend the teeth of a stopper member through fixed-side friction plates 81a.

In the brake device 380 according to the third embodiment, teeth 95a of a stopper member 95 extend through a substantially rectangular through-hole 381b formed on the outer peripheral side of the fixed-side friction plates 81a. Further, the teeth 95a of the stopper member 95 extend on the inner peripheral side of biasing members 93 in the same manner as in the brake device 280.

Also, in this embodiment, the stopper member 95 is abutted against a retaining plate 84 when a clearance adjustment piston 86 is moved toward the side of a friction plate set 81 to restrict movement of the clearance adjustment piston 86 at a position where a predetermined clutch clearance is formed. According to this configuration, it is possible to securely restrict movement of the clearance adjustment piston with a relatively simplified configuration.

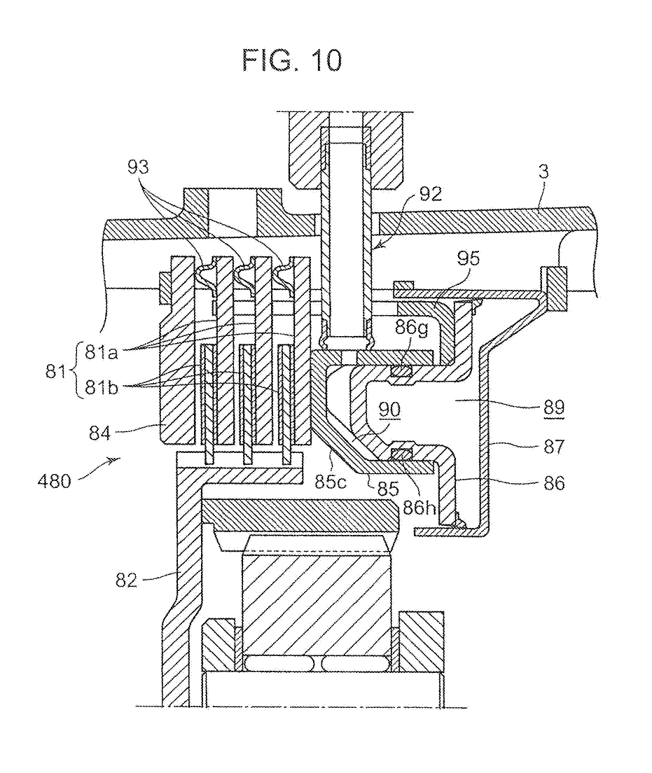

Further, in the brake device 80 according to the first embodiment, a portion of the bulging portion 85c of the engaging piston 85 in which the bulging portion 86c of the clearance adjustment piston 86 is received is sealed by the seal members 85d and 85e provided on the engaging piston 85. Alternatively, as exemplified by a brake device 480 according to a fourth embodiment illustrated in FIG. 10, a seal member may be provided on a clearance adjustment piston for sealing.

In the brake device 480 according to the fourth embodiment, seal members 86g and 86h are mounted on groove portions for seal members, which are respectively formed in the outer peripheral wall and in the inner peripheral wall of a bulging portion 86c of a clearance adjustment piston 86, and an outer periphery and an inner periphery of a bulging portion 85c of an engaging piston 85 in which the bulging portion 86c of the clearance adjustment piston 86 is received are respectively sealed by the seal members 86g and 86h. Thus, an engaging hydraulic chamber 90 is oil-tightly formed by the engaging piston 85 and the clearance adjustment piston 86.

Also, in this embodiment, the engaging hydraulic chamber 90 is formed by the bulging portion 85c of the engaging piston 85 bulging toward the side of a friction plate set 81, and the bulging portion 86c of the clearance adjustment piston 86 bulging toward the side of the friction plate set 81 and received in the bulging portion 85c. According to this configuration, it is possible to keep the volume of an engaging hydraulic chamber 89 substantially unchanged when the clearance adjustment piston 86 is moved toward the side of the friction plate set 81. This makes it possible to form the engaging hydraulic chamber 90 with a small size. Forming the engaging hydraulic chamber 90 with a small size is advantageous in engaging the friction plates with enhanced responsiveness, and in finely controlling the timing or the engaging force of an engaging operation.

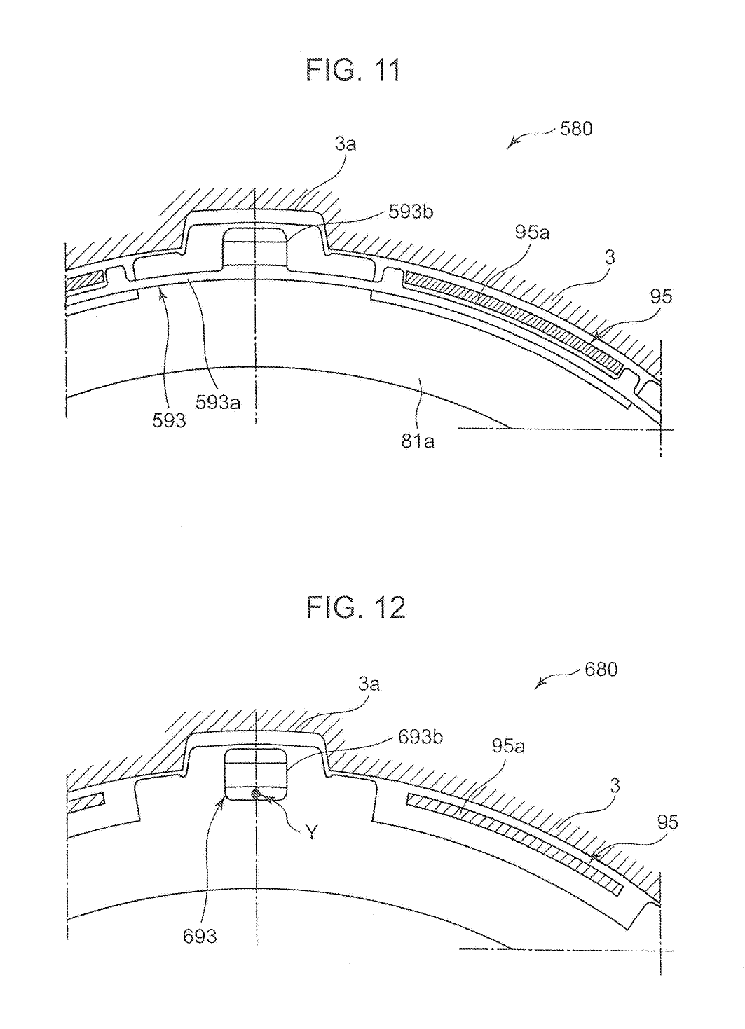

Further, in the brake device 80 according to the first embodiment, the biasing member 93 is formed by bending a wire member. Alternatively, as exemplified by a brake device 580 according to a fifth embodiment illustrated in FIG. 11, it is possible to form a biasing member by press-molding a plate-shaped member.

In the brake device 580 according to the fifth embodiment, a biasing member 593 is formed by press-molding a plate-shaped member. An annular body portion 593a is circumferentially formed with a biasing portion 593b at plural positions. Each of the biasing portions 593b is formed to project toward the rear side by bending the biasing portion 593b into a substantially V-shape in section in the same manner as the biasing portion 93b of the biasing member 93. As illustrated in FIG. 11, the biasing portion 593b is formed into a rectangular shape in plan view. Thus, the area of the biasing portion 593b in contact with a fixed-side friction plate 81a is made large, as compared with the biasing member 93.

Also, in this embodiment, the biasing member 593 for resiliently biasing each adjacent pair of the fixed-side friction plates 81a in directions away from each other are disposed between each adjacent pair of the fixed-side friction plates 81a. The biasing member 593 is provided in such a manner that a clutch clearance is distributed in a gap between each adjacent pair of the fixed-side friction plates when a hydraulic pressure is supplied only to a clearance adjustment hydraulic chamber 89.

According to the aforementioned configuration, it is possible to suppress a variation in the gap between each adjacent pair of the fixed-side friction plates 81a, and to make the gaps substantially uniform when a clutch clearance is reduced. This makes it possible to reduce a sliding resistance between friction plates, as compared with a configuration, in which the gaps are non-uniform. This is advantageous in improving the fuel economy.

Further, in the brake device 580 according to the fifth embodiment, the annular body 593a of the biasing member 593 is circumferentially formed with the biasing portion 593b at plural positions. Alternatively, as exemplified by a brake device 680 according to a sixth embodiment illustrated in FIG. 12, it is possible to form a plurality of biasing members circumferentially at plural positions, respectively, without forming an annular body portion of a biasing member.

In the brake device 680 according to the sixth embodiment, a biasing member 693 is formed in the same manner as the biasing portion 593b of the biasing member 593 according to the fifth embodiment. The biasing member 693 is disposed circumferentially at plural positions. The biasing member 693 is formed to project toward the rear side by bending the biasing member 693 into a substantially V-shape in section in the same manner as the biasing portion 593b of the biasing member 593. Then, only the inner peripheral portion of the biasing member 693 is connected to a fixed-sided friction plate 81a by rivet joint or the like at a position indicated by the symbol Y in FIG. 12.

Also, in this embodiment, a biasing member 693b for biasing each adjacent pair of the fixed-side friction plates 81a in directions away from each other is disposed between each adjacent pair of the fixed-side friction plates 81a. The biasing member 693b is provided to distribute a clutch clearance in a gap between each adjacent pair of the fixed-side friction plates when a hydraulic pressure is supplied only to a clearance adjustment hydraulic chamber 89.

According to this configuration, it is possible to suppress a variation in the gap between each adjacent pair of the fixed-side friction plates 81a, and to make the gaps substantially uniform when a clutch clearance is reduced. This makes it possible to reduce a sliding resistance between friction plates, as compared with a configuration, in which the gaps are non-uniform. This is advantageous in improving the fuel economy.

In the embodiments illustrated in FIG. 3 and FIG. 10, the outer peripheral portion of each of the fixed-side friction plates 81a is engaged with the spline 3a formed on the inner surface of the transmission case 3, and the inner peripheral portion of each of the rotation-side friction plates 81b is engaged with the spline 82a formed on the outer surface of the hub member 82. The retaining plate 84 is fixed to the inner surface of the transmission case 3. Alternatively, the relationship between the fixed-side friction plates 81a and the rotation-side friction plates 81b may be reversed. Specifically, a spline may be formed on the inner surface of the hub member 82, and an outer peripheral portion of each of the rotation-side friction plates 81b may be engaged with the spline. Then, a sleeve member may be disposed inside the hub member 82, and the sleeve member including an outer surface which faces the inner surface of the hub member 82 may be connected to the inner surface of the transmission case 3. A spline may be formed on the outer surface of the sleeve member, and the inner peripheral portion of each of the fixed-side friction plates 81a may be engaged with the spline. In this case, a retaining plate is fixed to the sleeve member.

In the foregoing embodiments, the LR brake 80 is described as a brake device according to the present invention. The present invention is also applicable to a brake device such as the R35 brake 60 and the 26 brake 70. Further, the present invention is also applicable to a friction engaging device such as a low clutch and a high clutch, wherein a clutch hub as an inner rotary member, and a clutch drum as an outer rotary member are axially disposed in an overlapping manner, in place of using a transmission case and a predetermined rotary member.

The present invention is not limited to the exemplified embodiments. Various improvements and design modifications are applicable as far as such improvements and design modifications do not depart from the gist of the present invention.

The following is a summary of the present invention.

Specifically, the present invention is directed to a transmission brake device including a friction plate set configured such that a plurality of rotation-side friction plates that are axially movably engaged with a predetermined rotary member, and a plurality of fixed-side friction plates that are axially movably engaged with a transmission case are alternately disposed; an engaging piston disposed on an axial side of the friction plate set; a clearance adjustment piston disposed on a side of the engaging piston opposite to the friction plate set, and configured to move the engaging piston toward the side of the friction plate set so as to adjust a clutch clearance; a clearance adjustment hydraulic chamber configured to move the clearance adjustment piston toward the side of the friction plate set when a hydraulic pressure is supplied to the clearance adjustment hydraulic chamber; and an engaging hydraulic chamber configured to move the engaging piston toward the side of the friction plate set when a hydraulic pressure is supplied to the engaging hydraulic chamber. The transmission brake device includes a biasing member disposed between each adjacent pair of the fixed-side friction plates, the biasing member being configured to bias each adjacent pair of the fixed-side friction plates in directions away from each other. The biasing member distributes the clutch clearance in a gap between each adjacent pair of the fixed-side friction plates when a hydraulic pressure is supplied only to the clearance adjustment hydraulic chamber out of the clearance adjustment hydraulic chamber and the engaging hydraulic chamber.

According to the aforementioned configuration, it is possible to suppress a variation in the gap between each adjacent pair of the fixed-side friction plates, and to make the gaps substantially uniform when a clutch clearance is reduced. This makes it possible to reduce a sliding resistance between friction plates, as compared with a configuration, in which the gaps are non-uniform. This is advantageous in improving the fuel economy.

Further, the biasing member which is disposed between each adjacent pair of the fixed-side friction plates can be used as a return spring for moving the engaging piston toward the side opposite to the side of the friction plate set. This is advantageous in obtaining the aforementioned effects without the need of additionally providing a return spring.

In the brake device, preferably, the biasing member may be circumferentially provided with a plurality of biasing portions for biasing each adjacent pair of the fixed-side friction plates in the directions away from each other.

According to the aforementioned configuration, it is possible to reduce the number of steps of assembling a biasing member, as compared with a configuration, in which a plurality of biasing members are provided circumferentially in a gap between each adjacent pair of the fixed-side friction plates. This is advantageous in improving productivity.

Further, in the brake device, preferably, the engaging piston may be provided with a bulging portion bulging toward the side of the friction plate set, the clearance adjustment piston may be provided with a bulging portion bulging toward the side of the friction plate set, the bulging portion of the clearance adjustment piston being received in the bulging portion of the engaging piston, and the engaging hydraulic chamber may be formed by the bulging portion of the engaging piston, and the bulging portion of the clearance adjustment piston received in the bulging portion of the engaging piston.

According to the aforementioned configuration, it is possible to keep the volume of the engaging hydraulic chamber substantially unchanged when the clearance adjustment piston is moved toward the side of the friction plate set. This makes it possible to form the engaging hydraulic chamber with a small size, as compared with a configuration, in which the volume of an engaging hydraulic chamber is increased. Forming the engaging hydraulic chamber with a small size is advantageous in engaging the friction plates with enhanced responsiveness, and in finely controlling the timing or the engaging force of an engaging operation.

Further, preferably, the brake device may be further provided with a retaining plate disposed axially on a side of the friction plate set opposite to the engaging piston; and a stopper member fixed to the clearance adjustment piston, and extending toward a side of the retaining plate. The stopper member may be abutted against the retaining plate when the clearance adjustment piston is moved toward the side of the friction plate set so as to restrict movement of the clearance adjustment piston at a position where the clutch clearance of a predetermined size is formed.

According to the aforementioned configuration, it is possible to securely restrict movement of the clearance adjustment piston with a relatively simplified configuration, without forming a groove portion for a seal member to mount the seal member, or forming a groove portion for a snap ring to mount the snap ring. Further, the aforementioned configuration is advantageous in improving productivity, as compared with a configuration, in which a groove portion for a seal member is formed in a clearance adjustment piston to mount the seal member, or a groove portion for a snap ring is formed to mount the snap ring.

### INDUSTRIAL APPLICABILITY

As described above, according to the present invention, it is possible to reduce a sliding resistance between friction plates at the time of non-engagement. Therefore, the present invention is suitably applicable to the technical field of manufacturing a transmission brake device including an engaging piston and a clearance adjustment piston, and to vehicles mounted with the transmission brake device.

1. A transmission brake device, comprising:
a friction plate set configured such that a plurality of rotation-side friction plates that are axially movably engaged with a predetermined rotary member, and a plurality of fixed-side friction plates that are axially movably engaged with a transmission case are alternately disposed;
an engaging piston disposed on an axial side of the friction plate set;
a clearance adjustment piston disposed on a side of the engaging piston opposite to the friction plate set, and configured to move the engaging piston toward the side of the friction plate set so as to adjust a clutch clearance;
a clearance adjustment hydraulic chamber configured to move the clearance adjustment piston toward the side of the friction plate set when a hydraulic pressure is supplied to the clearance adjustment hydraulic chamber; and
an engaging hydraulic chamber configured to move the engaging piston toward the side of the friction plate set when a hydraulic pressure is supplied to the engaging hydraulic chamber, wherein
the transmission brake device includes a biasing member disposed between each adjacent pair of the fixed-side friction plates, the biasing member being configured to bias each adjacent pair of the fixed-side friction plates in directions away from each other, and
the biasing member distributes the clutch clearance in a gap between each adjacent pair of the fixed-side friction plates when a hydraulic pressure is supplied only to the clearance adjustment hydraulic chamber out of the clearance adjustment hydraulic chamber and the engaging hydraulic chamber.

2. The transmission brake device according to claim 1, wherein
the biasing member is circumferentially provided with a plurality of biasing portions for biasing each adjacent pair of the fixed-side friction plates in the directions away from each other.

3. The transmission brake device according to claim 2, wherein
the engaging piston is provided with a bulging portion bulging toward the side of the friction plate set,
the clearance adjustment piston is provided with a bulging portion bulging toward the side of the friction plate set, the bulging portion of the clearance adjustment piston being received in the bulging portion of the engaging piston, and
the engaging hydraulic chamber is formed by the bulging portion of the engaging piston, and the bulging portion of the clearance adjustment piston received in the bulging portion of the engaging piston.

4. The transmission brake device according to claim 3, further comprising:
a retaining plate disposed axially on a side of the friction plate set opposite to the engaging piston; and
a stopper member fixed to the clearance adjustment piston, and extending toward a side of the retaining plate, wherein
the stopper member is abutted against the retaining plate when the clearance adjustment piston is moved toward the side of the friction plate set so as to restrict movement of the clearance adjustment piston at a position where the clutch clearance of a predetermined size is formed.

5. The transmission brake device according to claim 2, further comprising:
a retaining plate disposed axially on a side of the friction plate set opposite to the engaging piston; and
a stopper member fixed to the clearance adjustment piston, and extending toward a side of the retaining plate, wherein
the stopper member is abutted against the retaining plate when the clearance adjustment piston is moved toward the side of the friction plate set so as to restrict movement of the clearance adjustment piston at a position where the clutch clearance of a predetermined size is formed.

6. The transmission brake device according to claim 1, wherein
the engaging piston is provided with a bulging portion bulging toward the side of the friction plate set,
the clearance adjustment piston is provided with a bulging portion bulging toward the side of the friction plate set, the bulging portion of the clearance adjustment piston being received in the bulging portion of the engaging piston, and
the engaging hydraulic chamber is formed by the bulging portion of the engaging piston, and the bulging portion of the clearance adjustment piston received in the bulging portion of the engaging piston.

7. The transmission brake device according to claim 6, further comprising:
a retaining plate disposed axially on a side of the friction plate set opposite to the engaging piston; and
a stopper member fixed to the clearance adjustment piston, and extending toward a side of the retaining plate, wherein
the stopper member is abutted against the retaining plate when the clearance adjustment piston is moved toward the side of the friction plate set so as to restrict movement of the clearance adjustment piston at a position where the clutch clearance of a predetermined size is formed.

8. The transmission brake device according to claim 1, further comprising:
a retaining plate disposed axially on a side of the friction plate set opposite to the engaging piston; and
a stopper member fixed to the clearance adjustment piston, and extending toward a side of the retaining plate, wherein
the stopper member is abutted against the retaining plate when the clearance adjustment piston is moved toward the side of the friction plate set so as to restrict movement of the clearance adjustment piston at a position where the clutch clearance of a predetermined size is formed.
